(19) United States
(12) Patent Application Publication
(10) Pub. No.: US 2018/0363886 A1
(43) Pub. Date: Dec. 20, 2018

(54) THERMOPLASTIC LUMINAIRES FOR INDOOR LINEAR LIGHTING SYSTEMS

(71) Applicant: SABIC Global Technologies B.V., Bergen op Zoom (NL)

(72) Inventors: Venkatesha NARAYANASWAMY, Bangalore (IN); Dirk VELDMAN, Eindhoven (NL); Arunachala PARAMESHWARA, Bangalore (IN); Remesh KUZHIKKALI, Bangalore (IN); Nitesh Kumar SHET, Karnataka (IN); Murugan ARUMUGAN, Tamil Nadu (IN); Rajkumar KARTHIKEYAN, Tamil Nadu (IN)

(21) Appl. No.: 16/063,315

(22) PCT Filed: Dec. 22, 2016
(86) PCT No.: PCT/IB2016/057944

§ 371 Date: Jun. 18, 2018

(30) Foreign Application Priority Data
Dec. 23, 2015 (IN) 4256/DEL/2015

(51) Int. Cl. F21V 15/01; F21S 8/04; F21V 19/00; F21S 4/28

(52) U.S. Cl. CPC F21V 15/013; F21S 8/04; F21Y 2103/00; F21S 4/28; F21V 19/0055

(57) ABSTRACT

Luminaires and lighting system are disclosed. In one embodiment a luminaire includes a housing formed by a single non-metallic extruded piece, where the housing includes an outer wall and an inner wall, a reflector formed on or by an inner surface of the inner wall, and a retainer bracket disposed adjacent the reflector and configured to secure a light emitting element such that at least a portion of light emitted via the light emitting element reflects from the reflector.

### TECHNICAL FIELD

The present disclosure generally relates to lighting systems and more particularly to thermoplastic luminaires for linear lighting systems.

### BACKGROUND

A luminaire is a light unit used to artificially illuminate surfaces and objects with white light so that the reflected light may be reasonably seen by humans. Previous luminaire enclosures were at least partially made using thermally conductive metals, such as aluminum, stainless steel, and/or sheet metal, in order to dissipate heat effectively. The metal enclosures efficiently conducted heat away from the light source; however, the metal adds significant weight and cost to the luminaire. In addition, some applications have restrictions on the type of materials that may be used for the enclosure of the luminaires. For example, the presence of metal enclosures may be prohibited in some applications.

Moreover, in existing linear light emitting diode (LED) lighting systems, the number of parts is high (e.g., 13 component parts). As such, the product assembly time may be extended due to a large number of fasteners, such as screws, used to couple the component parts. Additionally, the conventional enclosure manufacturing process may require multiple secondary operations such as drilling, tapping, painting, and/or powder coating, for example.

As an example, FIG. 1 illustrates an exploded view of a conventional 48″ aluminum linear lighting system 100. As illustrated, two LED strips 102 are mounted on a steel reflector 104 using fasteners such as screws. An outer housing is formed from extruded aluminum frames 106 (e.g., 2 side parts and 1 top part). Driver units 107 (e.g., driver printed circuit boards enclosed in an electrically isolated housing) are assembled into the aluminum frames 106. A diffuser 109 is coupled to the aluminum frames 106. An end cap includes two components, namely, an inner cap 108 and an outer cover 110. The inner cap 108 is formed from die cast aluminum and the outer cover 110 is formed from plastic that is fixed over the inner cap 108. The inner cap 108 is fixed to the main aluminum frame 106 using fasteners (e.g., 3 screws).

As a further example, FIG. 2 illustrates a cross section of the conventional 48″ aluminum linear lighting system 100 shown in FIG. 1. As illustrated, the LED strips 102 are mounted to a steel reflector 104 using fasteners such as screws 200. One of skill in the art would understand that the steel reflector 104 may act as a primary heat sink for the LED strips 102. However, the aluminum frames 106 are not connected to the primary heat sink directly and thereby do not participate in thermal heat management. These and other shortcomings of the prior art are addressed by the present disclosure.

### SUMMARY

Luminaires and lighting system are disclosed. In one embodiment, a luminaire includes a housing formed by a single non-metallic extruded piece, where the housing includes an outer wall and an inner wall, a reflector formed on or by an inner surface of the inner wall, and a retainer bracket disposed adjacent the reflector and configured to secure a light emitting element such that at least a portion of light emitted via the light emitting element reflects from the reflector.

In another embodiment, a luminaire includes: a housing formed by a single non-metallic extruded piece, wherein the housing comprises an outer wall and an inner wall; a reflector formed on or by an inner surface of the inner wall; and a retainer disposed adjacent the reflector and configured to secure a light emitting element.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1 illustrates an exploded perspective view of a conventional metallic lighting system.

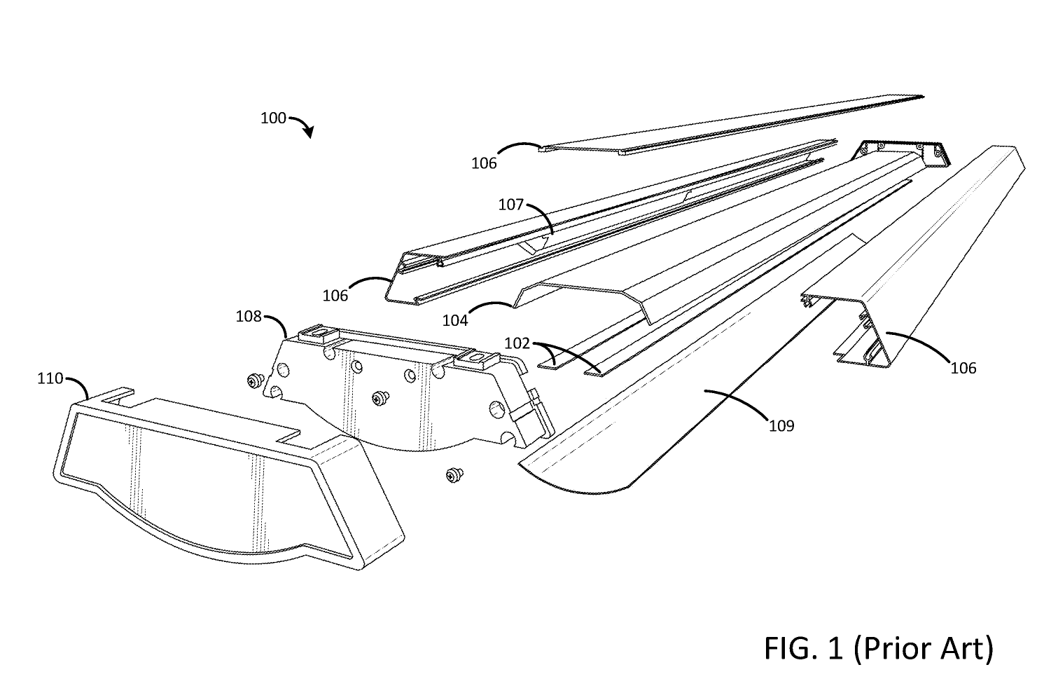

FIG. 2 illustrates a cross-sectional view of the conventional metallic lighting system of FIG. 1

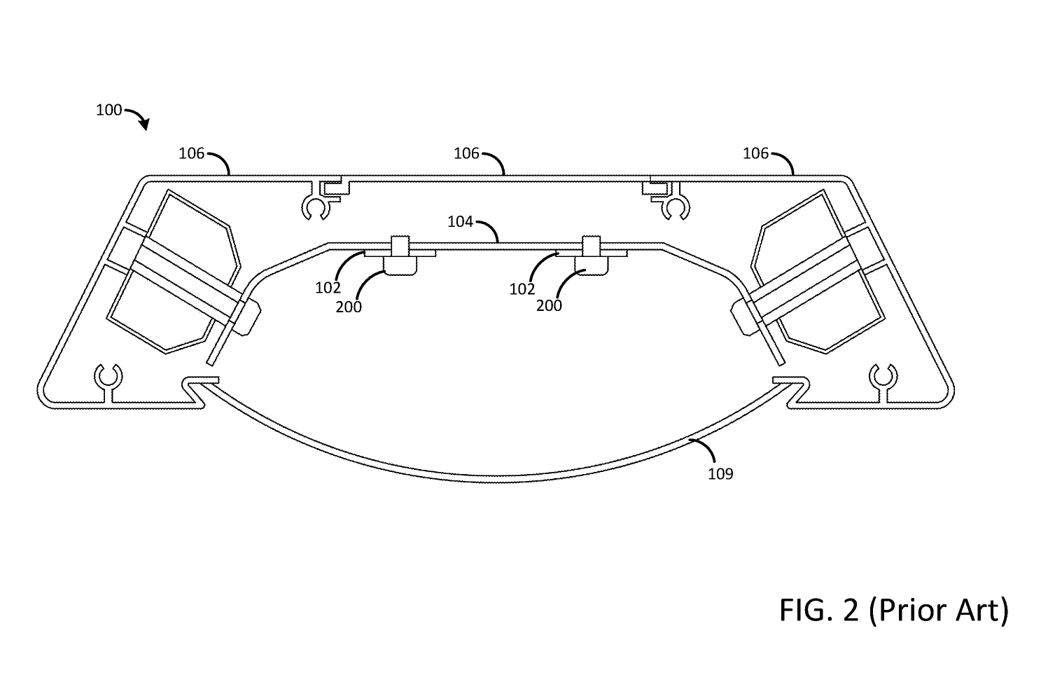

FIG. 3 illustrates a cross-sectional view of a luminaire according to an embodiment of the present disclosure.

FIG. 4A illustrates a cross-sectional view of a luminaire according to an embodiment of the present disclosure.

FIG. 4B illustrates example cross member configurations according to various embodiments of the present disclosure.

FIG. 5 illustrates a cross-sectional view of a luminaire according to an embodiment of the present disclosure.

FIG. 6 illustrates a perspective view of an end cap according to an embodiment of the present disclosure.

FIG. 7 illustrates a perspective view of the end cap of FIG. 6 coupled to a housing of a luminaire according to an embodiment of the present disclosure.

FIG. 8 illustrates a rear perspective view of an end cap according to an embodiment of the present disclosure.

FIG. 9 illustrates a front perspective view of the end cap of FIG. 8

FIG. 10 illustrates simulated results of a thermal model of a luminaire according to the present disclosure.

FIG. 11 illustrates simulated results of a thermal model of a luminaire according to the present disclosure.

FIG. 12 illustrates a graphical plot of experimental data of thermal performance of a luminaire according to the present disclosure.

FIG. 13 illustrates a schematic mapping of thermocouple placement used in acquiring the test results illustrated in FIG. 12.

### DETAILED DESCRIPTION

In various examples disclosed herein, thermoplastic luminaires for lighting systems such as linear LED lighting systems provide part integration and process improvements that reduce the number of necessary secondary operations and the overall assembly time. Furthermore, the thermoplastic luminaires of the present disclosure provide a reduction in overall weight over conventional lighting system formed from metals.

Reference will now be made in detail to exemplary aspects, examples of which are illustrated in the accompanying figures. The following description refers to the accompanying drawings in which the same numbers in different drawings represent the same or similar elements when practical. The implementations set forth in the following description of exemplary embodiments do not represent all implementations consistent with the disclosure. Instead, they are merely examples of systems and methods consistent with aspects of the disclosure as recited in the appended claims.

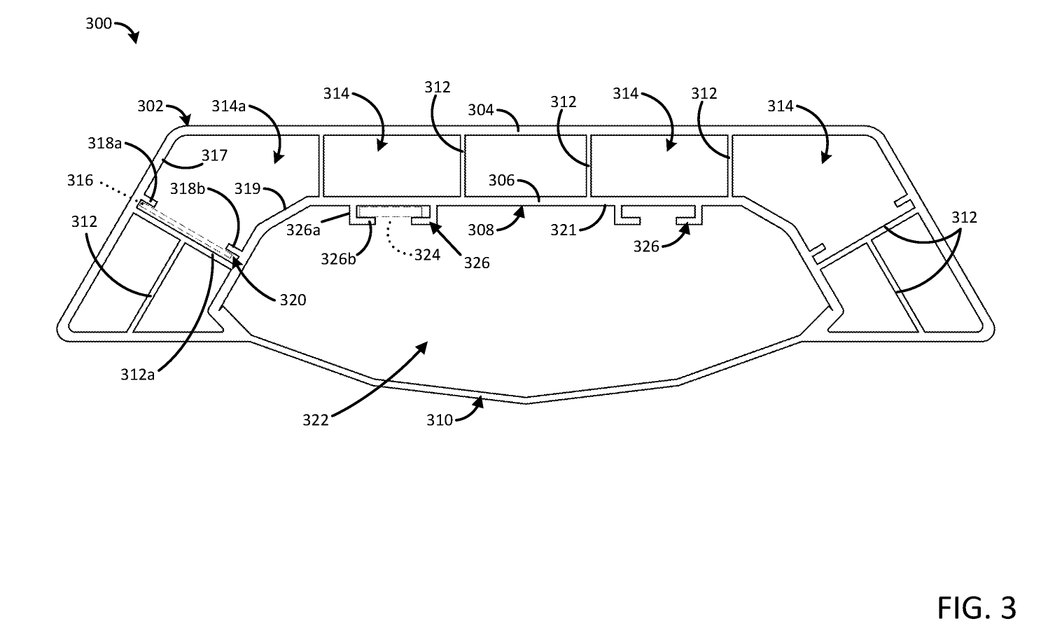

FIG. 3 illustrates a cross-sectional view of a luminaire 300, which may be part of a lighting system such as a linear LED lighting system. The luminaire 300 is shown having a multi-wall housing 302 including an outer wall 304 and an inner wall 306. The housing 302 may be formed in any shape and may be co-formed (e.g., co-extruded) with an integrated reflector 308 and/or diffuser 310, as will be described in further detail below. As an example, the inner wall 306 may form at least a portion of the reflector 308.

The outer wall 304 and the inner wall 306 may be spaced from each other. At least a portion of each of the outer wall 304 and the inner wall 306 may be in parallel configuration with each other. However, other configurations and alignments may be used. One or more cross members 312 may be interposed between the outer wall 304 and the inner wall 306. As an example, at least one of the cross members 312 may be orthogonal to one or more of the outer wall 304 and the inner wall 306. As a further example, at least one of the cross members 312 may be coupled to another of the cross members 312 and/or one or more of the outer wall 304 and the inner wall 306. As illustrated, at least two cross members 312 may be configured in a generally “T” shaped configuration, whereby one of the cross members 312 is orthogonal to another of the cross members 312 and each of the two cross members 312 is coupled to at least one of the outer wall 304 and the inner wall 306. In some aspects, the cross members 312 may be configured to provide strength and rigidity to the luminaire 300. Additionally, theses cross members provide pathway for heat generated by the LED chips from the inner wall to the outer wall and eventually to the ambient.

The outer wall 304, the inner wall 306, and/or the cross members 312 may define one or more cavities 314 (e.g., volumes). The cavities 314 may extend along at least a portion of a longitudinal axis of the luminaire 300 (extending into the page of FIG. 3, for example). At least one of the cavities 314 may be configured to house at least a portion of an electrical component associated with the luminaire 300 such as a controller, a driver, a circuit board, a printed circuit board (PCB) 316, or other component of a lighting system. As shown, a plurality of retainers 318 may be disposed to extend from one or more of the outer wall 304 and the inner wall 306. As an example, the retainers 318 may be formed (extruded, or CNC routed) with the housing 302. As illustrated, a first retainer 318a may be disposed on an inner surface 317 of the outer wall 304 and may extend into a first cavity 314a. A second retainer 318b may be disposed on an outer surface 319 of the inner wall 306 and may extend into the first cavity 314a, toward the first retainer 318a. Each of the first retainer 318a and the second retainer 318b may be spaced from a first cross member 312a to create a gap 320 configured to receive the PCB 316. As an example, the PCB 316 may be or comprise an LED driver PCB and may be translated in the gap 320 during assembly of the lighting system. As such, the PCB 316 and components coupled to the PCB 316 may be electrically isolated within the first cavity 314a (except for electrical leads).

At least a portion of an inner surface 321 of the inner wall 306 may be configured as a reflective surface, which may embody the reflector 308. As an example, at least the inner surface 321 of the inner wall 306 may be formed to have a reflective property. As another example, the full thickness of the inner wall 306 may be configured to exhibit a reflective property. As a another example, the reflector 308 may have reflectivity of greater than 70%, greater than 80%, greater than 90%, or greater than 85% at about 450 to about 650 nm (nanometers). As a further example, the reflector 308 may be configured to not be color selective (e.g., white surface color). The diffuser 310 may be integrated with or coupled to the housing 302. As an example, the diffuser 310 may be co-extruded with the housing 302. As a further example, the diffuser 310 may be separately formed and may be coupled to the housing 302. The diffuser 310 may be configured to allow light to pass therethrough. For example, the diffuser 310 may be configured to have a transmittance of greater than 70% of visible light. As another example, a certain amount of light may be reflected by the diffuser 310 and the reflector 308 within a volume between the reflector 308 and the diffuser and may be configured to operate as a wavelength converting element.

The diffuser 310 and the reflector 308 may define a reflective cavity 322 configured to house a light emitting element such as one or more LED strips 324. As an example, fasteners such as screws may be used to secure the LED strips 324 to the housing 302. As another example, retaining brackets 326 may be disposed on the inner surface 321 of the inner wall 306 and may be configured to support a light emitting element such as the LED strips 324. As shown, the retaining brackets 326 may have a generally “L” shaped structure, wherein each of the retaining brackets 326 includes a first member 326a disposed orthogonal to at least a portion of the inner surface 321 of the inner wall 306 and a second member 326b disposed parallel to at least a portion of the inner surface of the inner wall 306. Although the first member 326a is illustrated in an orthogonal configuration, such a configuration may include generally orthogonal placement, wherein an angle between the first member 326a and the inner wall 306 is not 90 degrees. Similarly, the second member 326b may not be exactly parallel with the inner wall 306, but may still be effective to retain a component such as a light emitting element. As such, various configurations of brackets and retaining features may be used. It is understood that various configurations of the inner wall 306 and the reflector 308 may be used in conjunction with the placement of light emitting devices to direct light out of the reflective cavity 322.

The housing 302 may be formed via an extrusion process and may be formed from any material that can be extruded, such as a polymer (thermoset or thermoplastic), glass, ceramics, and the like. As an example, the extrudable polymer may be or comprise polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), polyphenylene sulfide (PPS), glass-filled polypropylene (PP), and/or co-polymers or compounds thereof. The polymers may also be compounded with additives to provide additional functions such as fire-resistance, UV stability, thermal conductivity or strength. Fluorinated polymers such as ETFE and PVDF may also be used. As a further example, the extrudable polymers may be or comprise a PC resin such as KONDUIT™ PX13322 (e.g., thermally conductive mineral filled PA6), LEXAN™ Resin 103 (any color code), LEXAN™ Resin 955 (any color code) or LEXAN™ SD1318 polycarbonate (any color code). In certain embodiments, for example, where additional UV protection is desired for outdoor applications, the housing material may be covered/coated with a layer of LEXAN™ SD1274 polycarbonate (any color code).

The reflector 308 may be formed via an extrusion process and may be formed from any material that can be extruded, such as a polymer (thermoset or thermoplastic), glass, ceramics, and the like. The reflector 308 may be formed to have reflectivity of greater than 70%, greater than 80%, greater than 90%, or greater than 85% at about 450 to about 650 nm. In certain examples, the reflector 308 may be formed via extrusion and reflectivity may be modified using a secondary process. For example, reflectivity may be obtained via specular (metallic) or diffuse (white) materials and/or additives, white or metallic coatings, or by texturing. The extrudable polymer used for the reflector 308 may be or comprise polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), and/or co-polymers or compounds thereof. Fluorinated polymers such as ETFE and PVDF may also be used. As a further example, the extrudable polymers may be or comprise a PC resin such as KONDUIT™ PX13322, LEXAN™ Resin 103 (any color code), LEXAN™ Resin 955 (any color code) or LEXAN™ SD1318 polycarbonate (any color code). In certain embodiments, the reflector 308 may comprise an optically reflective extrudable resin, such as a PC resin mixed with an additive such as TiO2. Such a resin comprises LEXAN™ 103 (color WH8C015) or LEXAN™ Resin 955 (color 8T9D042), or (higher reflectivity) LEXAN™ LUX2719 (color WH9G012). The highly reflective LEXAN™ LUX2719 (color WH9G012) grade may also be used as a capping layer to provide the reflective properties.

The diffuser 310 may be formed via an extrusion process and may be formed from any material that can be extruded, such as a polymer (thermoset or thermoplastic), glass, ceramics, and the like. The diffuser may be formed to have transmittance of greater than about 70% of visible light. The diffuser may have a structured surface to diffuse or direct the light or the diffuser may comprise diffusing particles to diffuse the light. The diffuser 310 may be co-extruded with the housing 302 or may be coupled to the housing 302 via a means other than co-extrusion, hence the material used for the diffuser 310 is not limited to an extruded material. However, the diffuser 310 may be formed from extrudable materials such as polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), and/or co-polymers thereof. In certain examples, the diffuser may comprise an optically clear PC resin such as LEXAN™ 103 (color NA9G208T) or diffusive (translucent) PC resin such as LEXAN™ LUX1814N (color WH2G007X).

As described herein, the luminaire 300 may formed via extrusion and may include different material (e.g., PC) grades that are co-extruded. For example, a first grade material may be used for the housing 302, a second grade material (e.g., with higher reflectivity) may be used for the reflector 308, and a third grade material (e.g., transparent or diffusive) may be used for the diffuser 310. Other forming processes using one or multiple materials may be used to form the luminaire as a single piece.

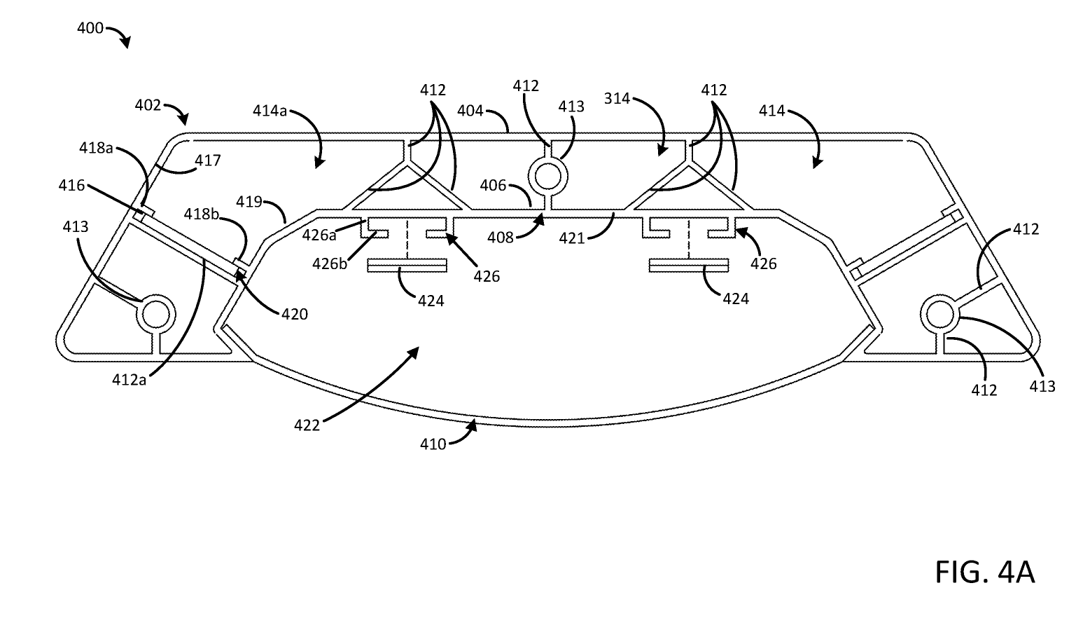

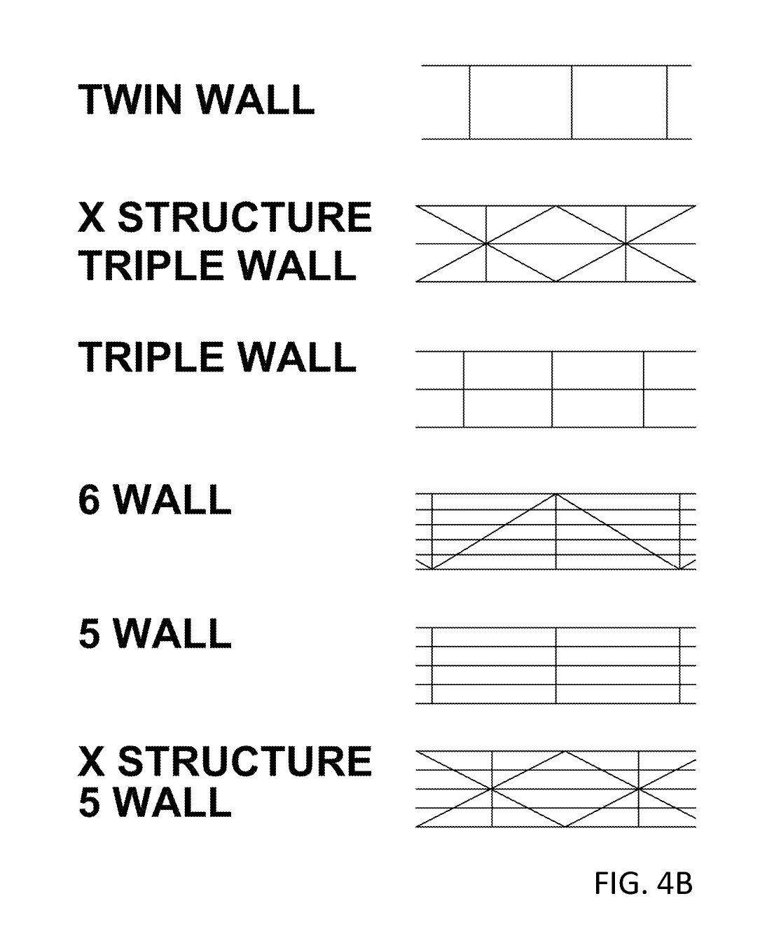

FIG. 4A illustrates a cross-sectional view of a luminaire 400, which may be similar to the luminaire 300 (FIG. 3), except as described below. The luminaire 400 may be part of a lighting system such as a linear LED lighting system. The luminaire 400 is shown having a multi-wall housing 402 including an outer wall 404 and an inner wall 406. The housing 402 may be formed in any shape and may be co-formed (e.g., co-extruded) with an integrated reflector 408 and/or diffuser 410, as will be described in further detail below.

The outer wall 404 and the inner wall 406 may be spaced from each other. At least a portion of each of the outer wall 404 and the inner wall 406 may be in parallel configuration with each other. However, other configurations and alignments may be used. One or more cross members 412 may be interposed between the outer wall 404 and the inner wall 406. As an example, at least one of the cross members 412 may be orthogonal to one or more of the outer wall 404 and the inner wall 406. As a further example, at least one of the cross members 412 may be coupled to another of the cross members 412 and/or one or more of the outer wall 404 and the inner wall 406. In some aspects, the cross members 412 may be configured to provide strength and rigidity to the luminaire 400. As illustrated, at least two cross members 412 may be configured to support a boss 413 configured to receive a fastener therein. One or more bosses 413 may be disposed and supported between the outer wall 404 and the inner wall 406. The bosses 413 may have a generally annular shape and may be configured to receive a self tapping screw or other fastener. The cross members 412 may be configured in various supportive arrangements such as a star arrangement (e.g., three-pointed star arrangement), an angled arrangement, a “T” shaped arrangement, a linear arrangement and/or the like. As an example, additional or alternative configurations of the cross members 412 are illustrated in FIG. 4B. As another example, the cross members 412 may be configured to provide structural stiffness to the housing 402 and/or impact properties. As a further example, the cross members 412 may provide thermal conductivity for managing thermal energy of the system. The cross members 412 may be formed from the same or different material as the housing 402, which may include a polymer (thermoset or thermoplastic), glass, ceramics, and the like. As an example, the extrudable polymer may be or comprise polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), PPS, glass-filled PP, and/or co-polymers or compounds thereof. The polymers may also be compounded with additives to provide additional functions such as fire-resistance, UV stability, thermal conductivity or strength. Fluorinated polymers such as ETFE and PVDF may also be used. As a further example, the extrudable polymers may be or comprise a PC resin such as KONDUIT™ PX13322, LEXAN™ Resin 103 (any color code), LEXAN™ Resin 955 (any color code) or LEXAN™ SD1318 polycarbonate (any color code).

Returning to FIG. 4A, The outer wall 404, the inner wall 406, and/or the cross members 412 may define one or more cavities 414 (e.g., volumes). The cavities 414 may extend along at least a portion of a longitudinal axis of the luminaire 400 (extending into the page of FIG. 4, for example). At least one of the cavities 414 may be configured to house at least a portion of an electrical component associated with the luminaire 400 such as a controller, a driver, a circuit board, a printed circuit board (PCB) 416 or other component of a lighting system. As shown, a plurality of retainers 418 may be disposed to extend from one or more of the outer wall 404 and the inner wall 406. As an example, the retainers 418 may be co-extruded with the housing 402. As illustrated, a first retainer 418a may be disposed on an inner surface 417 of the outer wall 404 and may extend into a first cavity 414a. A second retainer 418b may be disposed on an outer surface 419 of the inner wall 406 and may extend into the first cavity 414a, toward the first retainer 418a. Each of the first retainer 418a and the second retainer 414b may be spaced from a first cross member 412a to create a gap 420 configured to receive the PCB 416. As an example, the PCB 416 may be or comprise an LED driver PCB and may be translated in the gap 420 during assembly of the lighting system. As such, the PCB 416 and components coupled to the PCB 416 may be electrically isolated within the first cavity 414a (except for electrical leads).

At least a portion of an inner surface 421 of the inner wall 406 may be configured as a reflective surface, which may embody the reflector 408. As an example, at least the inner surface 421 of the inner wall 406 may be formed to have a reflective property. As a another example, the reflector 408 may have reflectivity of greater than 70%, greater than 80%, greater than 90%, or greater than 85% at about 450 to about 650 nm. As a further example, the reflector 408 may be configured to not be color selective (e.g., white surface color). The diffuser 410 may be integrated with or coupled to the housing 402. As an example, the diffuser 410 may be co-extruded with the housing 402. As a further example, the diffuser 410 may be separately formed and may be coupled to the housing 402. The diffuser 410 may be configured to allow light to pass therethrough. For example, the diffuser 410 may be configured to have a transmittance of greater than 70% of visible light.

The diffuser 410 and the reflector 408 may define a reflective cavity 422 configured to house a light emitting element such as one or more LED strips 424 (e.g. LEDs soldered on an FR4 or other PCB). As an example, retaining brackets 426 may be disposed on the inner surface 421 of the inner wall 406 and may be configured to support a light emitting element such as the LED strips 424. As shown, the retaining brackets 426 may have a generally “L” shaped structure, wherein each of the retaining brackets 426 includes a first member 426a disposed orthogonal to at least a portion of the inner surface 421 of the inner wall 406 and a second member 426b disposed parallel to at least a portion of the inner surface of the inner wall 406. Although the first member 426a is illustrated in an orthogonal configuration, such a configuration may include generally orthogonal placement, wherein an angle between the first member 426a and the inner wall 406 is not 90 degrees. Similarly, the second member 426b may not be exactly parallel with inner wall 406, but may still be effective to retain a component such as a light emitting element. As such, various configurations of brackets and retaining features may be used. It is understood that various configurations of the inner wall 406 and the reflector 408 may be used in conjunction with the placement of light emitting devices to direct light out of the reflective cavity 422.

The housing 402 may be formed via an extrusion process and may be formed from any material that can be extruded, such as a polymer (thermoset or thermoplastic), glass, ceramics, and the like. As an example, the extrudable polymer may be or comprise polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), PPS, glass-filled PP, and/or co-polymers or compounds thereof. The polymers may also be compounded with additives to provide additional functions such as fire-resistance, UV stability, thermal conductivity or strength. Fluorinated polymers such as ETFE and PVDF may also be used. As a further example, the extrudable polymers may be or comprise a PC resin such as KONDUIT™ PX13322, LEXAN™ Resin 103 (any color code), LEXAN™ Resin 955 (any color code) or LEXAN™ SD1318 polycarbonate (any color code). In certain embodiments, for example, where additional UV protection is desired for outdoor applications, the housing material may be covered/coated with a layer of LEXAN™ SD1274 polycarbonate (any color code).

The reflector 408 may be formed via an extrusion process and may be formed from any material that can be extruded, such as a polymer (thermoset or thermoplastic), glass, ceramics, and the like. The reflector 408 may be formed to have reflectivity of greater than 70%, greater than 80%, greater than 90%, or greater than 85% at about 450 to about 650 nm. In certain examples, the reflector 408 may be formed via extrusion and reflectivity may be modified using a secondary process. For example, reflectivity may be obtained via specular (metallic) or diffuse (white) materials and/or additives, white or metallic coatings, or by texturing. The extrudable polymer used for the reflector 308 may be or comprise polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (Pp, polymethylmethacrylimide (PMMI), and/or co-polymers thereof. Fluorinated polymers such as ETFE and PVDF may also be used. As a further example, the extrudable polymers may be or comprise a PC resin such as KONDUIT TM PX13322, LEXAN™ Resin 103 (any color code), LEXAN™ Resin 955 (any color code) or LEXAN™ SD1318 polycarbonate (any color code). In certain embodiments, the reflector 408 may comprise an optically reflective extrudable resin, such as a PC resin mixed with an additive such as TiO2. Such a resin comprises LEXAN™ 103 (color WH8C015) or LEXAN™ Resin 955 (color 8T9D042), or (higher reflectivity) LEXAN™ LUX2719 (color WH9G012). The highly reflective LEXAN™ LUX2719 (color WH9G012) grade may also be used as a capping layer to provide the reflective properties.

The diffuser 410 may be formed via an extrusion process and may be formed from any material that can be extruded, such as a polymer (thermoset or thermoplastic), glass, ceramics, and the like. The diffuser may be formed to have transmittance of greater than about 70% of visible light. The diffuser may have a structured surface to diffuse or direct the light or the diffuser may comprise diffusing particles to diffuse the light. The diffuser 410 may be co-extruded with the housing 402 or may be coupled to the housing 402 via a means other than co-extrusion, hence the material used for the diffuser 410 is not limited to an extruded material. However, the diffuser 410 may be formed from extrudable materials such as polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), and/or co-polymers thereof. In certain examples, the diffuser may comprise an optically clear PC resin such as LEXAN™ 103 (color NA9G208T) or diffusive (translucent) PC resin such as LEXAN™ LUX1814N (color WH2G007X).

As described herein, the luminaire 400 may formed via extrusion and may include different material (e.g., PC) grades that are co-extruded. For example, a first grade material may be used for the housing 402, a second grade material (e.g., with higher reflectivity) may be used for the reflector 408, and a third grade material (e.g., transparent or diffusive) may be used for the diffuser 410. Other forming processes using one or multiple materials may be used to form the luminaire as a single piece.

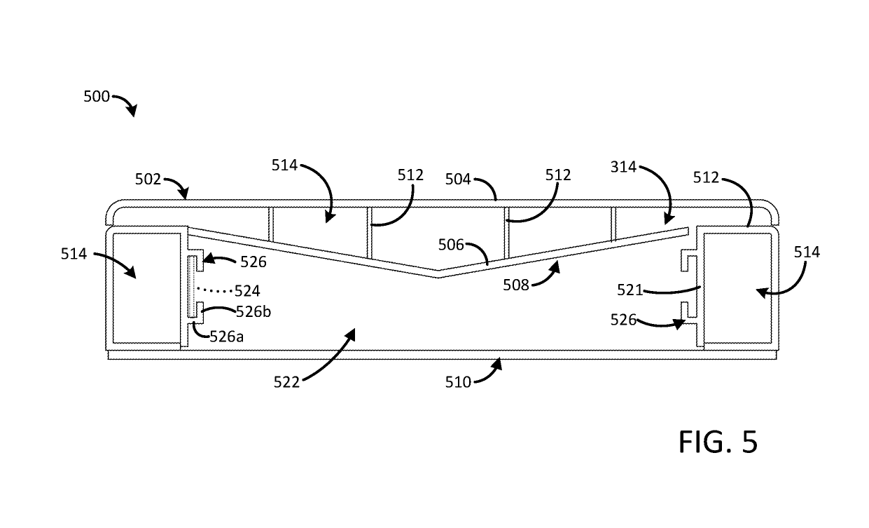

FIG. 5 illustrates a cross-sectional view of a luminaire 500, which may be similar to the luminaire 300 (FIG. 3) and/or the luminaire 400 (FIG. 4), except as described below. The luminaire 500 may be part of a lighting system such as a linear LED lighting system. The luminaire 500 is shown having a multi-wall housing 502 including an outer wall 504 and an inner wall 506. The housing 502 may be formed in any shape and may be co-formed (e.g., co-extruded) with an integrated reflector 508 and/or diffuser 510, as will be described in further detail below.

The outer wall 504 and the inner wall 506 may be spaced from each other. At least a portion of each of the outer wall 504 and the inner wall 506 may be in a parallel configuration with each other. However, other configurations and alignments may be used. For example, at least a portion of the inner wall 506 may be angled to provide directional control over reflected light rays. As shown, one or more cross members 512 may be interposed between the outer wall 504 and the inner wall 506. As an example, at least one of the cross members 512 may be orthogonal to one or more of the outer wall 504 and the inner wall 506. In some aspects, the cross members 512 may be configured to provide strength and rigidity to the luminaire 500.

The outer wall 504, the inner wall 506, and/or the cross members 512 may define one or more cavities 514 (e.g., volumes). The cavities 514 may extend along at least a portion of a longitudinal axis of the luminaire 500 (extending into the page of FIG. 5, for example). At least one of the cavities 514 may be configured to house at least a portion of a printed circuit board (PCB) 416 or other component of a lighting system. As an example, one or more retainers (not shown) may be configured to secure a component in one or more of the cavities 514.

At least a portion of an inner surface 521 of the inner wall 506 may be configured as a reflective surface, which may embody the reflector 508. As an example, at least the inner surface 521 of the inner wall 506 may be formed to have a reflective property. As a another example, the reflector 508 may have reflectivity of greater than 70%, greater than 80%, greater than 90%, or greater than 85% at about 450 to about 650 nm. As a further example, the reflector 508 may be configured to not be color selective (e.g., white surface color). The diffuser 510 may be integrated with or coupled to the housing 502. As an example, the diffuser 510 may be co-extruded with the housing 502. As a further example, the diffuser 510 may be separately formed and may be coupled to the housing 502. The diffuser 510 may be configured to allow light to pass therethrough. For example, the diffuser 510 may be configured to have a transmittance of greater than 70% of visible light.

The diffuser 510 and the reflector 508 may define a reflective cavity 522 configured to house a light emitting element such as one or more LED strips 524 (e.g. LEDs soldered on an FR4 or other PCB). As an example, retaining brackets 526 may be disposed on the inner surface 521 of the inner wall 506 and may be configured to support a light emitting element such as the LED strips 524. As shown, the retaining brackets 526 may have a generally “L” shaped structure, wherein each of the retaining brackets 526 includes a first member 526a disposed orthogonal to the inner surface 521 of the inner wall 506 and a second member 526b disposed parallel to the inner surface 521 of the inner wall 506. Although the first member 526a is illustrated in an orthogonal configuration, such a configuration may include generally orthogonal placement, wherein an angle between the first member 526a and the inner wall 506 is not 90 degrees. Similarly, the second member 526b may not be exactly parallel with inner wall 506, but may still be effective to retain a component such as a light emitting element. As such, various configurations of brackets and retaining features may be used. As illustrated in FIG. 5, the retaining brackets 526 are disposed along a vertical portion of the inner wall 506 such that at least a portion of light emitted from a light emitting device secured by the retaining brackets 526 is reflected from an angled portion of the inner wall 506. It is understood that various configurations of the inner wall 506 and the reflector 508 may be used in conjunction with the placement of light emitting devices to direct light to exit the reflective cavity 522.

The housing 502 may be formed via an extrusion process and may be formed from any material that can be extruded, such as a polymer (thermoset or thermoplastic), glass, ceramics, and the like. As an example, the extrudable polymer may be or comprise polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), PPS, glass-filled PP, and/or co-polymers or compounds thereof. The polymers may also be compounded with additives to provide additional functions such as fire-resistance, UV stability, thermal conductivity or strength. Fluorinated polymers such as ETFE and PVDF may also be used. As a further example, the extrudable polymers may be or comprise a PC resin such as KONDUIT™ PX13322, LEXAN™ Resin 103 (any color code), LEXAN™ Resin 955 (any color code) or LEXAN™ SD1318 polycarbonate (any color code). In certain embodiments, for example, where additional UV protection is desired for outdoor applications, the housing material may be covered/coated with a layer of LEXAN™ SD1274 polycarbonate (any color code).

The reflector 508 may be formed via an extrusion process and may be formed from any material that can be extruded, such as a polymer (thermoset or thermoplastic), glass, ceramics, and the like. The reflector 508 may be formed to have reflectivity of greater than 70%, greater than 80%, greater than 90%, or greater than 85% at about 450 to about 650 nm. In certain examples, the reflector 508 may be formed via extrusion and reflectivity may be modified using a secondary process. For example, reflectivity may be obtained via specular (metallic) or diffuse (white) materials and/or additives, white or metallic coatings, or by texturing. The extrudable polymer used for the reflector 308 may be or comprise polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), and/or co-polymers thereof. Fluorinated polymers such as ETFE and PVDF may also be used. As a further example, the extrudable polymers may be or comprise a PC resin such as KONDUIT™ PX13322, LEXAN™ Resin 103 (any color code), LEXAN™ Resin 955 (any color code) or LEXAN™ SD1318 polycarbonate (any color code). In certain embodiments, the reflector 508 may comprise an optically reflective extrudable resin, such as a PC resin mixed with an additive such as TiO2. Such a resin comprises LEXAN™ 103 (color WH8C015) or LEXAN™ Resin 955 (color 8T9D042), or (higher reflectivity) LEXAN™ LUX2719 (color WH9G012). The highly reflective LEXAN™ LUX2719 (color WH9G012) grade may also be used as a capping layer to provide the reflective properties.

The diffuser 510 may be formed via an extrusion process and may be formed from any material that can be extruded, such as a polymer (thermoset or thermoplastic), glass, ceramics, and the like. The diffuser may be formed to have transmittance of greater than about 70% of visible light. The diffuser may have a structured surface to diffuse or direct the light or the diffuser may comprise diffusing particles to diffuse the light. The diffuser 510 may be co-extruded with the housing 502 or may be coupled to the housing 502 via a means other than co-extrusion, hence the material used for the diffuser 510 is not limited to an extruded material. However, the diffuser 510 may be formed from extrudable materials such as polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), and/or co-polymers thereof. In certain examples, the diffuser may comprise an optically clear PC resin such as LEXAN™ 103 (color NA9G208T) or diffusive (translucent) PC resin such as LEXAN™ LUX1814N (color WH2G007X).

As described herein, the luminaire 500 may be formed via extrusion and may include different material (e.g., PC) grades that are co-extruded. For example, a first grade material may be used for the housing 502, a second grade material (e.g., with higher reflectivity) may be used for the reflector 508, and a third grade material (e.g., transparent or diffusive) may be used for the diffuser 510. Other forming processes using one or multiple materials may be used to form the luminaire as a single piece.

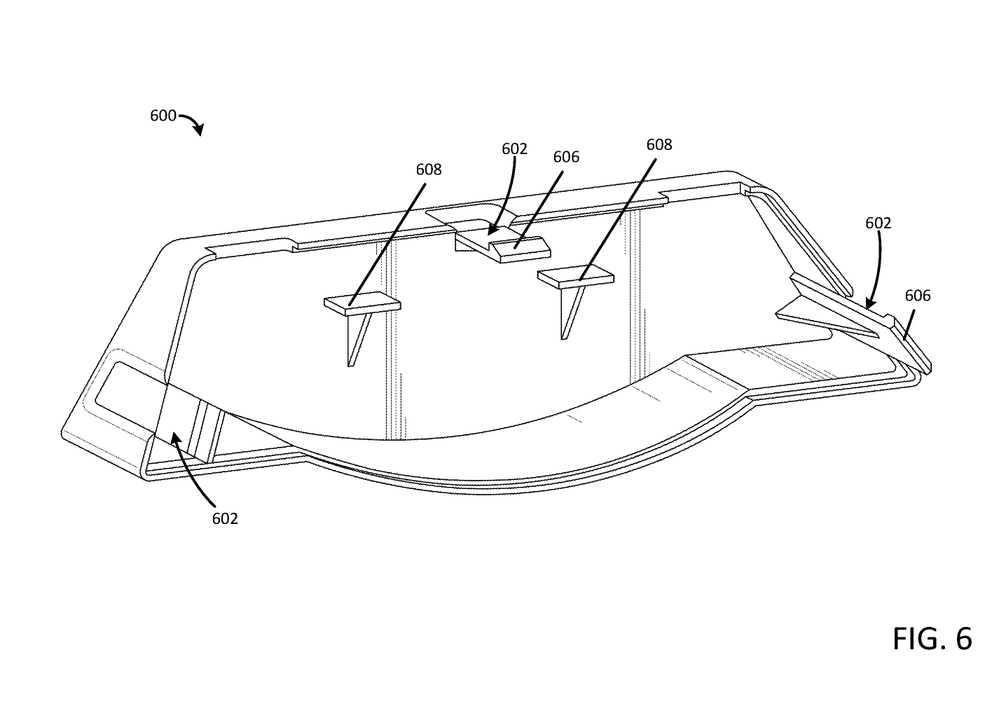

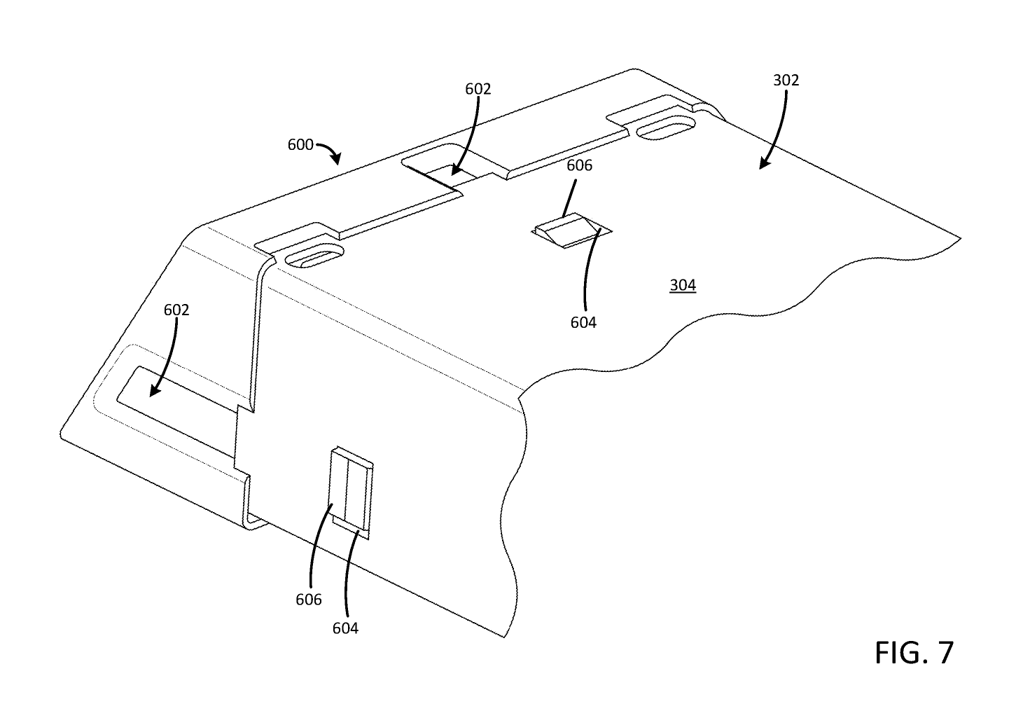

FIG. 6 illustrates a perspective view of an end cap 600 that may be configured to couple to an end of the luminaire 300, 400, 500. As shown, the end cap 600 may be formed to a general contour of the cross section of the luminaire 300, 400, 500. The end cap 600 may include one or more snap fit features 602 configured to be received by a portion of the luminaire 300, 400, 500. The end cap 600 may include one or more stopper features 608 configured to engage a portion of the LED strips 324, 424, 524 to secure the LED strips 324, 424, 524 inside the housing 302, 402, 502. As an example, FIG. 7 illustrates the end cap 600 coupled to the housing 302 of the luminaire 300. As shown, a plurality of orifices 604 may be formed in the housing 302 to receive at least a portion of the snap fit features 602. In certain embodiments, a metallic clip may be disposed adjacent an edge of one or more of the orifices 604 to minimize creep of the housing 302. As an example, each of the snap fit features 602 may include a lip 606 that may extend through a respective one of the orifices 604 and may engage a portion of the respective orifice 604 to retain the end cap 600 in a pre-determined position. When retained, at least a portion of the end cap 600 may abut an outer surface of the outer wall 304 of the housing 302, while at least a portion of the snap fit features 602 are disposed adjacent the inner surface 317 of the outer wall 304 of the housing 302. As such, additional coupling features to secure the end cap 600 to the housing 302 may not be necessary. Although reference is made to the luminaire 300, it is understood that the housings 402, 502 of the respective luminaire 400, 500, may be coupled to the end cap 600 in a similar manner and may utilize a slightly modified shaped to conform to the cross-sectional shape of the luminaire 400, 500.

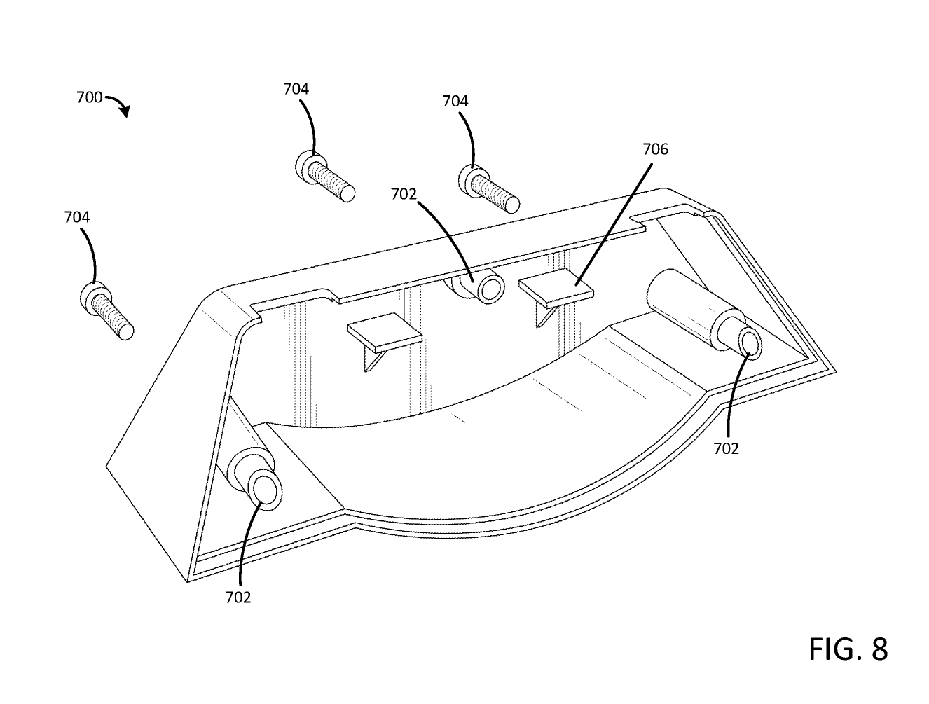

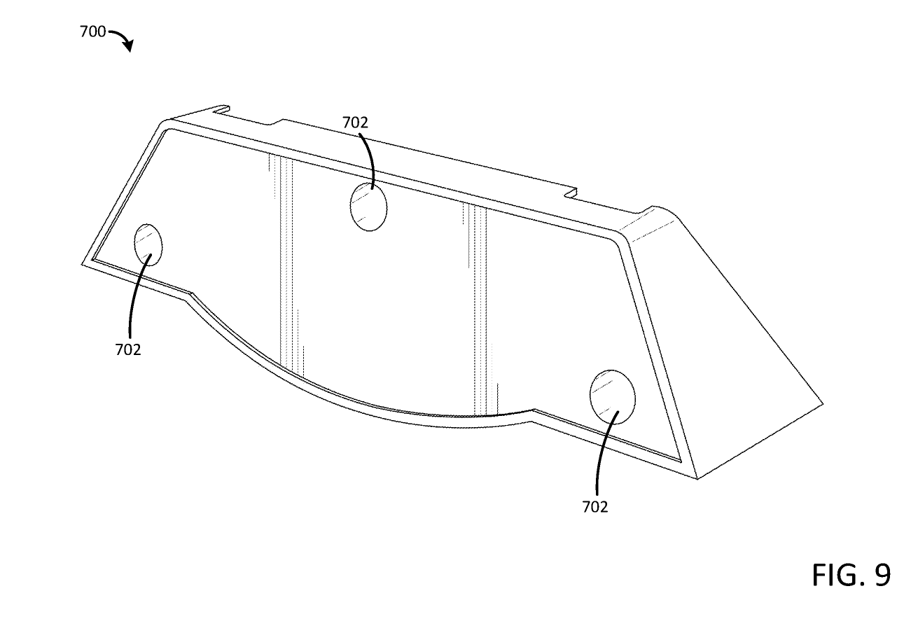

FIGS. 8-9 illustrate an end cap 700 that may be configured to couple to an end of the luminaire 300, 400, 500. As shown, the end cap 700 may be formed to a general contour of the cross section of the luminaire 300, 400, 500. The end cap 700 may include one or more stopper features 706 configured to engage a portion of the LED strips 324, 424, 524 to secure the LED strips 324, 424, 524 inside the housing 302, 402, 502. The end cap 700 may include one or more through-holes 702 configured to receive a fastener 704 such as a screw. As an example, the end cap 700 may be coupled to the housing 402 of the luminaire 400. As such, each of the through-holes 702 may be registered or aligned with a respective one of the bosses 413 such that the fastener 704 may be disposed via the through-hole 702 and may engage the respective boss 413 to secure the end cap 700 to the housing 402 of the luminaire 400. When retained, at least a portion of the end cap 700 may abut the outer surface 419 of the outer wall 404 of the housing 402. Although reference is made to the luminaire 300, it is understood that the housings 302, 502 of the respective luminaire 300, 500, maybe be configured to be coupled to the end cap 700 in a similar manner. In certain embodiments, an end of the housing 302, 402, 502 may be formed or cut at an angle (e.g., 30 degrees). As such, the end caps 600, 700 may be configured to fit the angled arrangement of the end of the respective housing 302, 402, 502. Other configurations may be used.

In various aspects, the present disclosure pertains to and includes at least the following examples.

### EXAMPLE 1

A luminaire comprising: a linearly extended non-metallic housing formed by a single extruded piece, wherein the housing comprises an outer wall and an inner wall; a reflector formed on or by an inner surface of the inner wall; a first retainer disposed between the outer wall and the inner wall and configured to secure an electrical component; and a second retainer disposed adjacent the reflector and configured to secure a light emitting element such that at least a portion of light emitted via the light emitting element directly or indirectly reflects from the reflector.

### EXAMPLE 2

A luminaire comprising: a housing formed by a single non-metallic extruded piece, wherein the housing comprises an outer wall and an inner wall; a reflector formed on or by an inner surface of the inner wall; and a retainer disposed adjacent the reflector and configured to secure a light emitting element.

### EXAMPLE 3

The luminaire of any of examples 1-2, further comprising a diffuser disposed in relation to the reflector to define a reflective cavity.

### EXAMPLE 4

The luminaire of example 3, wherein the diffuser is coupled to at least a portion of the housing or is formed by the single extruded piece.

### EXAMPLE 5

The luminaire of any of examples 3-4, wherein two or more of the outer wall, the inner wall, and the diffuser are co-extruded using different materials.

### EXAMPLE 6

The luminaire of any of examples 1-5, wherein the diffuser comprises a polymer, glass, or ceramic, or a combination thereof.

### EXAMPLE 7

The luminaire of any of examples 1-5, wherein the diffuser comprises polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), or compounds or co-polymers thereof, or a combination thereof.

### EXAMPLE 8

The luminaire of any of examples 1-7, wherein the diffuser exhibits a transmittance of greater than about 70% for visible light.

### EXAMPLE 9

The luminaire of any of examples 1-8, wherein the housing comprises a polymer, glass, or ceramic, or a combination thereof.

### EXAMPLE 10

The luminaire of any of examples 1-9, wherein the housing polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), or (glass-filled) polypropylene (PP), poly(p-phenylene oxide (PPO), poly(p-phenylene sulfide) (PPS), polyethylenimine (PEI) or compounds or co-polymers thereof, or a combination thereof.

### EXAMPLE 11

The luminaire of any of examples 1-10, wherein the reflector comprises polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), thermal conductive filled polymers, or compounds or co-polymers thereof, or a combination thereof.

### EXAMPLE 12

The luminaire of any of examples 1-11, wherein the reflector exhibits reflectivity of greater than 70%.

### EXAMPLE 13

The luminaire of any of examples 1-12, further comprising at least one cross member interposed between the outer wall and the inner wall of the housing.

### EXAMPLE 14

The luminaire of any of examples 1-13, further comprising at least one boss configured to receive a fastener, wherein the boss is disposed between the outer wall and the inner wall of the housing.

### EXAMPLE 15

The luminaire of any of examples 1-14, further comprising an end cap configured to couple to an end of the housing.

### EXAMPLE 16

The luminaire of example 15, wherein the end cap comprises a snap-fit feature configured to engage at least a portion of the housing to effect coupling of the end cap to the housing.

### EXAMPLE 17

The luminaire of any of examples 15-16, wherein the end cap is formed from a polymer.

### EXAMPLE 18

A lighting system comprising: a linearly extended non-metallic housing formed by a single extruded piece, wherein the housing comprises an outer wall and an inner wall; at least one cross member interposed between the outer wall and the inner wall; a reflector formed on or by an inner surface of the inner wall; an electrical component disposed between the outer wall and the inner wall; and a light emitting element disposed such that at least a portion of light emitted via the light emitting element reflects from the reflector.

### EXAMPLE 19

The lighting system of example 18, further comprising a diffuser disposed in relation to the reflector to define a reflective cavity.

### EXAMPLE 20

The lighting system of example 19, wherein one or more of the housing, the reflector, and the diffuser is formed from a polymer, glass, ceramic, or a combination thereof.

### Thermal Performance Modeling

Computational modeling of thermal performance of a linear LED lighting system was conducted using luminaire 400, a PCB with copper traces, an aluminum strip disposed adjacent the modeled LED lighting strip, and end cap 700. Material proprieties of the modeled components are shown in Table 1.

TABLE 1

| | | | Specific | Thermal |
|---|---|---|---|---|
| | | Density, | heat, | Conductivity, |
| Component | Material | kg/m³ | J/kgK | W/mK |
| Co-extruded | Konduit | 1,520 | 1,250 | 1.82 |
| Assembly | PX13322 | | | |
| PCB | FR-4 with | 1,850 | 880 | 3 |
| | Copper traces | | | |
| Al Strip | Aluminum | 2,700 | 900 | 85 |
| End Cap | Lexan | 1,200 | 1,250 | 0.19 |

The following modeling assumptions were implemented:
1. Entire co-extruded luminaire 400 is made of Konduit PX13322 (white).
2. Out of the total input power, it is assumed that 30% of the power is consumed by the driver unit and 70% by the LEDs.
3. Power conversion efficiency of the LEDs are assumed to be 35%, i.e., 35% of the power input to the LED is converted as light and 65% as heat.
4. The LED was attached to the heat sink body and the contact between the LED and the heat sink was assumed to be perfect, i.e., no air gap between the LED chip and the heat sink.
5. Radiation heat transfer is considered in the present analysis. Surface emissivity is assumed to be 0.27.

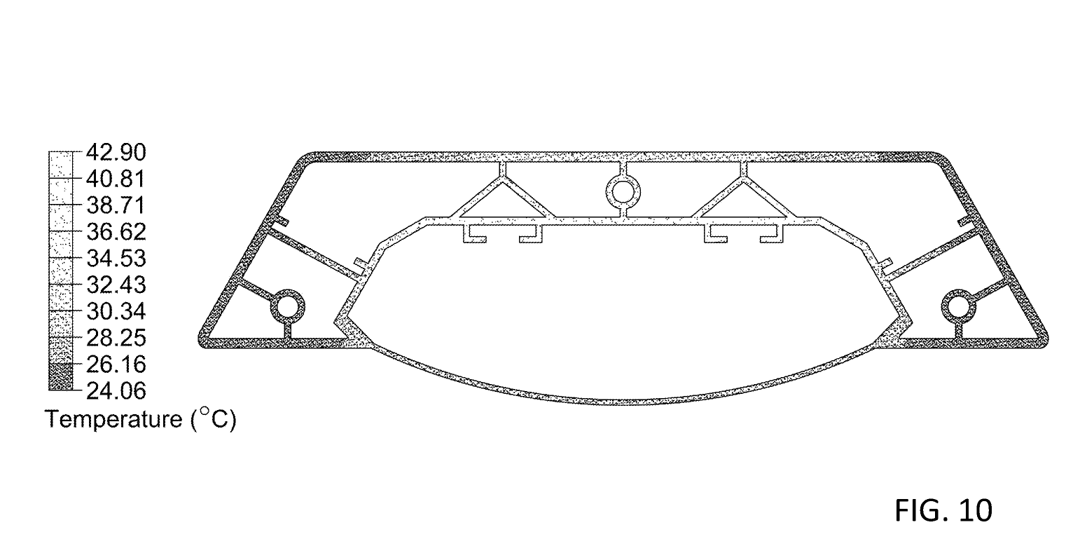

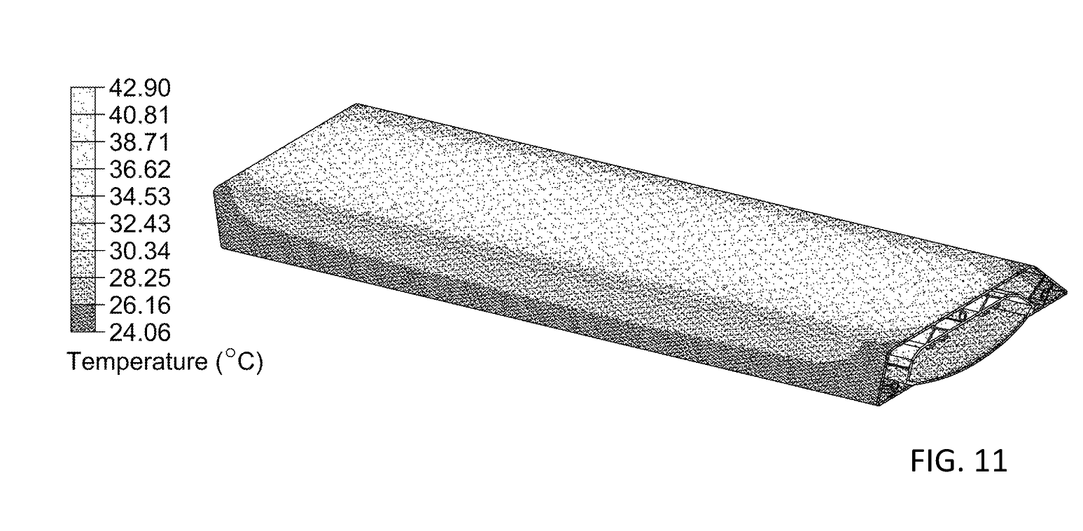

Simulation results from the above modeling are illustrated in FIGS. 10-11.

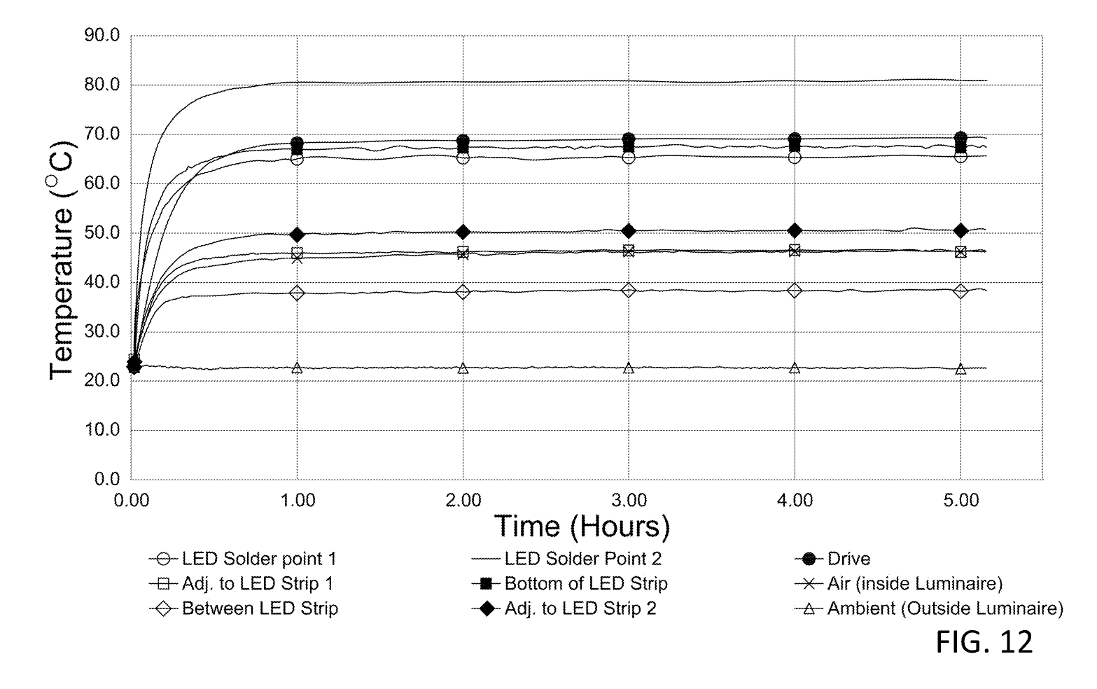

FIG. 12 illustrates experimental results from testing according to the following conditions using a KEYSIGHT U803 1A Triple Output DC Power Supply (30V/6 A (2×) & 5V/3 A; 375 W) with 230V AC input voltage, an Agilent 34972A LXI Data Acquisition/Switch Unit, and a Testo 890-2 thermal imager using the following experimental setup:

| | |
|---|---|
| Power | 40 W/110 VAC |
| No. of LED's | 55 × 2 strips |
| Lumens | 3200 |
| No. of thermocouple used | 9 |
| Thermocouple type | J-type |
| Height | 0.8 meter from Base |
| Duration of test | 5 hours |

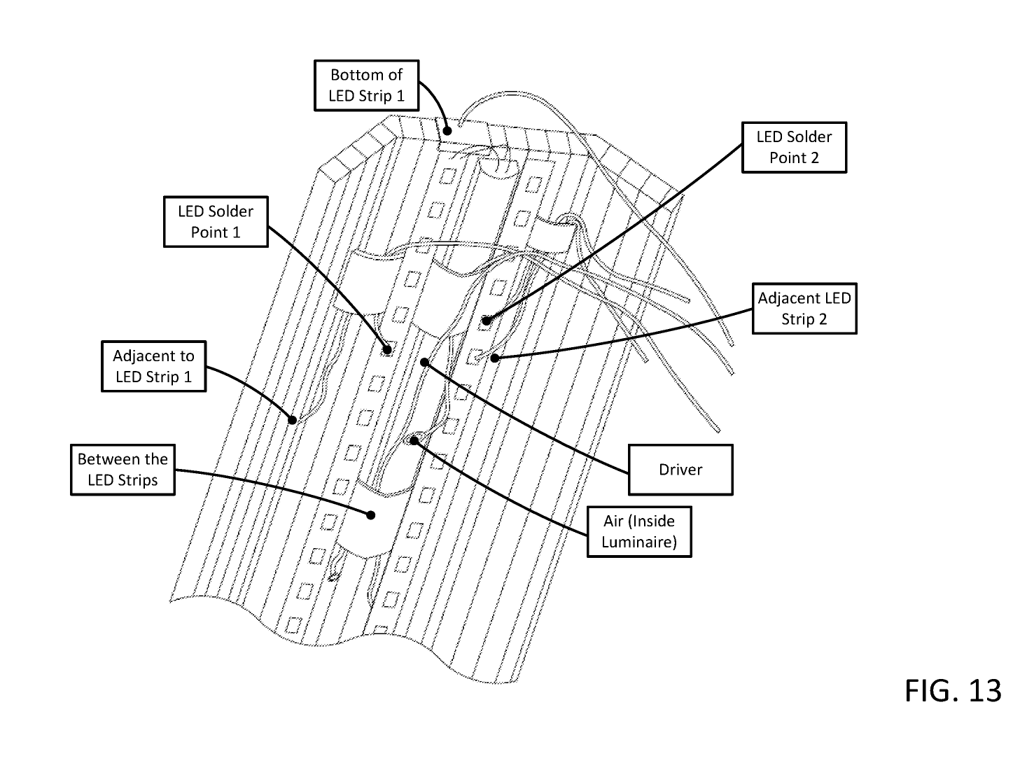

The results illustrated in FIG. 12 were taken via thermocouples placed in accordance with FIG. 13. The tested luminaire was formed from LEXAN™ Thermoclear Plus 2UV with a multiwall extruded housing having: thickness (T)=10 mm, width (W)=190 mm, and length (L)=1220 mm in a similar configuration as shown below:

The housing of the tested luminaire was a multiwall extruded product having a top layer thickness: 0.75 mm, bottom layer thickness : 0.6 mm, and vertical member thickness: 0.5 mm, similar to the following configuration:

The disclosed subject matter associated with a thermoplastic luminaire has been described with reference to several examples. It should be understood, however, that the words used are for descriptive and illustrative purposes, rather than as mere limitations. Although the thermoplastic luminaire has been described in terms of particular means, processes, materials, technologies, and the like, the disclosed subject matter extends to functionally equivalent technologies, structures, methods, and uses that are within the scope of the claims.

1. A luminaire comprising:
a linearly extended non-metallic housing formed by a single extruded piece, wherein the housing comprises an outer wall and an inner wall;
a reflector formed on or by an inner surface of the inner wall;
a first retainer disposed between the outer wall and the inner wall and configured to secure an electrical component; and
a second retainer disposed adjacent the reflector and configured to secure a light emitting element such that at least a portion of light emitted via the light emitting element directly or indirectly reflects from the reflector.

2. (canceled)

3. The luminaire of claim 1, further comprising a diffuser disposed in relation to the reflector to define a reflective cavity.

4. The luminaire of claim 3, wherein the diffuser is coupled to at least a portion of the housing or is formed by the single extruded piece.

5. The luminaire of claim 3, wherein two or more of the outer wall, the inner wall, and the diffuser are co-extruded using different materials.

6. The luminaire of claim 1, wherein the diffuser comprises a polymer, glass, or ceramic, or a combination thereof.

7. The luminaire of claim 1, wherein the diffuser comprises polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), or compounds or co-polymers thereof, or a combination thereof.

8. The luminaire of claim 1, wherein the diffuser exhibits a transmittance of greater than about 70% for visible light.

9. The luminaire of claim 1, wherein the housing comprises a polymer, glass, or ceramic, or a combination thereof.

10. The luminaire of claim 1, wherein the housing polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), or (glass-filled) polypropylene (PP), poly(p-phenylene oxide (PPO), poly(p-phenylene sulfide) (PPS), polyethylenimine (PEI)or compounds or co-polymers thereof, or a combination thereof.

11. The luminaire of claim 1, wherein the reflector comprises polycarbonate (PC), polystyrene (PS), polyethylene naphthalate (PEN), polybutylene terephthalate (PBT), polyethylene terephthalate (PET), poly(methyl methacrylate) (PMMA), polyamide (PA), polyvinylchloride (PVC), polyoxymethylene (POM), polyimide (PI), polymethylmethacrylimide (PMMI), thermal conductive filled polymers, or compounds or co-polymers thereof, or a combination thereof.

12. The luminaire of claim 1, wherein the reflector exhibits reflectivity of greater than 70%.

13. The luminaire of claim 1, further comprising at least one cross member interposed between the outer wall and the inner wall of the housing.

14. The luminaire of claim 1, further comprising at least one boss configured to receive a fastener, wherein the boss is disposed between the outer wall and the inner wall of the housing.

15. The luminaire of claim 1, further comprising an end cap configured to couple to an end of the housing.

16. The luminaire of claim 15, wherein the end cap comprises a snap-fit feature configured to engage at least a portion of the housing to effect coupling of the end cap to the housing.

17. The luminaire of claim 15, wherein the end cap is formed from a polymer.

18. A lighting system comprising:
a linearly extended non-metallic housing formed by a single extruded piece, wherein the housing comprises an outer wall and an inner wall;
at least one cross member interposed between the outer wall and the inner wall;
a reflector formed on or by an inner surface of the inner wall;
an electrical component disposed between the outer wall and the inner wall; and
a light emitting element disposed such that at least a portion of light emitted via the light emitting element reflects from the reflector.

19. The lighting system of claim 18, further comprising a diffuser disposed in relation to the reflector to define a reflective cavity.

20. The lighting system of claim 19, wherein one or more of the housing, the reflector, and the diffuser is formed from a polymer, glass, ceramic, or a combination thereof.
